(19) United States
(12) Patent Application Publication
(10) Pub. No.: US 2013/0154418 A1
(43) Pub. Date: Jun. 20, 2013

(54) SPINDLE MOTOR

(71) Applicant: SAMSUNG ELECTRO-MECHANICS CO., LTD., Suwon (KR)

(72) Inventor: Sang Jae SONG, Suwon (KR)

(73) Assignee: SAMSUNG ELECTRO-MECHANICS CO., LTD., Suwon (KR)

(21) Appl. No.: 13/711,941

(22) Filed: Dec. 12, 2012

(30) Foreign Application Priority Data
Dec. 15, 2011 (KR) 10-2011-0135257

(51) Int. Cl. H02K 5/16

(52) U.S. Cl. CPC H02K 5/165
USPC 310/90

(57) ABSTRACT

There is provided a spindle motor, including: a hub rotated together with a shaft; a sleeve supporting rotation of the shaft via oil; and a stopper mounted on the hub to prevent the hub from overfloating with respect to the sleeve, wherein one of opposing surfaces of the stopper and the hub is provided with at least one press-fitting groove for press-fitting the stopper in the hub, and the other of the opposing surfaces of the stopper and the hub is provided with at least one press-fitting protrusion press-fitted to the press-fitting groove.

### CROSS-REFERENCE TO RELATED APPLICATIONS

This application claims the priority of Korean Patent Application No. 10-2011-0135257 filed on Dec. 15, 2011, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor that may be applied to a hard disk drive (HDD) rotating a recording disk.

2. Description of the Related Art

A hard disk drive (HDD), an information storage device, is a device that reads data stored on a disk or writes data to a disk, using a read/write head.

The hard disk drive requires a disk driving apparatus capable of driving a disk, and in the disk driving apparatus, a spindle motor is commonly used.

The spindle motor uses a fluid dynamic bearing in which a shaft is supported by fluid pressure generated in oil interposed between the shaft, a rotating member, and a sleeve, a fixed member.

In the spindle motor according to the related art, a stopper for preventing the rotating members from overfloating is disposed below the shaft. In this case, an axial length of the sleeve is relatively short, due to a space occupied by the stopper, such that a rigidity of a bearing may be weak.

Further, in the case that an external impact is applied to the spindle motor, the stopper structure according to the related art may not be able to maintain the rigidity of a hub, such that the hub may be separated from the shaft.

Therefore, research into improving the rigidity of the bearing and significantly improving spindle motor performance and lifespan by preventing the separation of the hub due to an external impact have been urgently required.

According to the following Related Art Document, a flange for preventing rotating members from overfloating is disposed below a shaft, such that rigidity of a bearing may be degraded.
[Related Art Document]
Japanese Patent Laid-Open Publication No. 2010-281349

### SUMMARY OF THE INVENTION

An aspect of the present invention provides a spindle motor capable of preventing a position of a stopper from being changed while improving rigidity of a bearing, thereby improving performance and lifespan of the spindle motor.

According to an aspect of the present invention, there is provided a spindle motor, including: a hub rotated together with a shaft; a sleeve supporting rotation of the shaft via oil; and a stopper mounted on the hub to prevent the hub from overfloating with respect to the sleeve, wherein one of opposing surfaces of the stopper and the hub is provided with at least one press-fitting groove for press-fitting the stopper in the hub, and the other of the opposing surfaces of the stopper and the hub is provided with at least one press-fitting protrusion that is press-fitted to the press-fitting groove.

The press-fitting groove may be formed in the stopper and the press-fitting protrusion may be formed on the hub.

The press-fitting groove may be formed in an upper surface of the stopper and the press-fitting protrusion may be formed on one surface of the hub facing the upper surface of the stopper.

The press-fitting groove and the press-fitting protrusion may be seamlessly or spacedly formed in a circumferential direction.

The press-fitting groove and the press-fitting protrusion may be symmetrically formed, based on a rotational center of the shaft.

The hub may be provided with a wall part that is protruded axially downwardly from an outer surface of the sleeve, and the stopper may be mounted on the wall part.

An outer circumferential surface of the stopper and an inner circumferential surface of the wall part may be coupled to each other by an adhesive.

The stopper may contact the sleeve to prevent the shaft from overfloating.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a spindle motor according to an embodiment of the present invention;

FIG. 2 is a schematic cut-away perspective view illustrating a sleeve provided in a spindle motor according to the embodiment of the present invention;

FIG. 3 is a schematic exploded cut-away perspective view illustrating a hub and a stopper provided in the spindle motor according to the embodiment of the present invention;

FIG. 4 is a schematic cut-away perspective view illustrating a hub and a stopper coupled by press-fitting in the spindle motor according to the embodiment of the present invention; and

FIG. 5 is a schematic cut-away perspective view (illustrating section A of FIG. 4) illustrating a state in which the hub and the stopper are fixed to each other by an adhesive after the hub and the stopper provided in the spindle motor according to the embodiment of the present invention are coupled by press-fitting.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

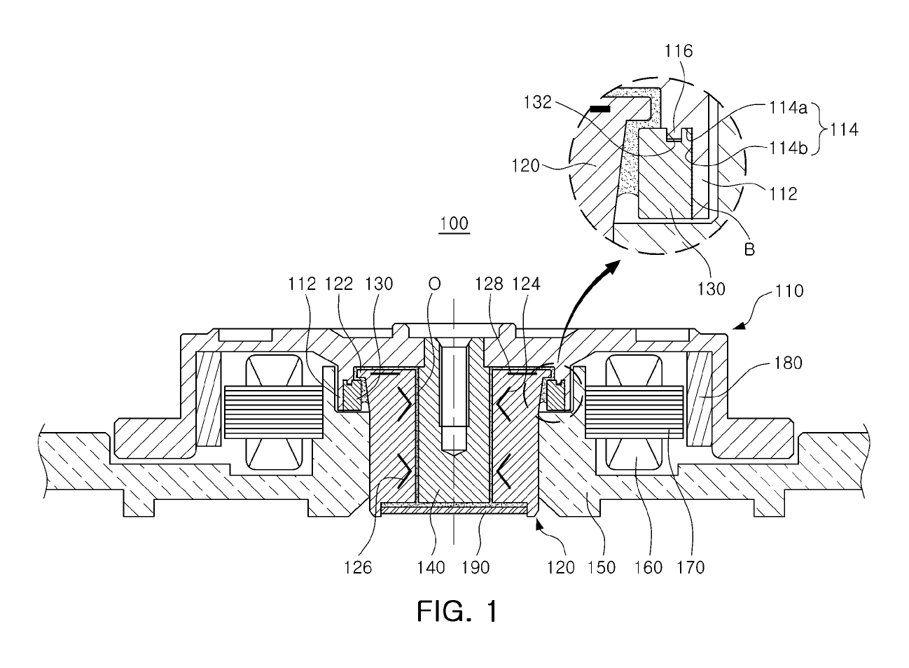

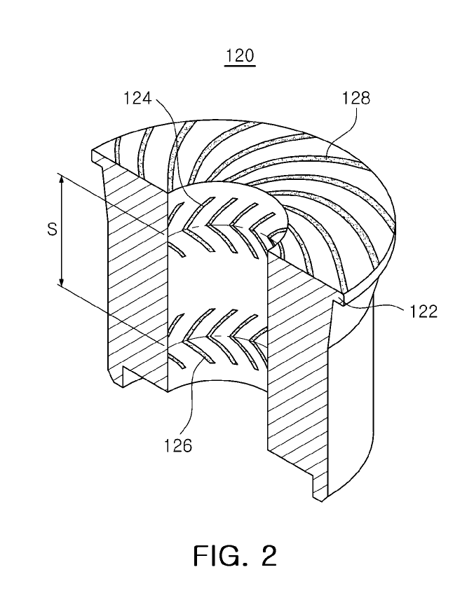

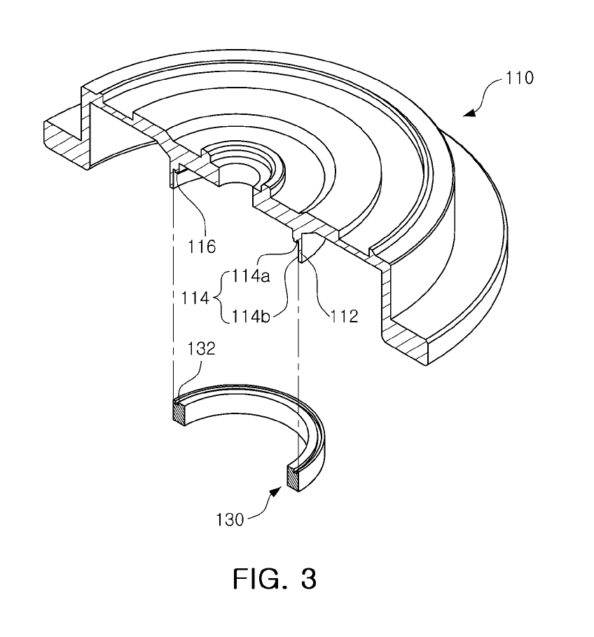

FIG. 1 is a schematic cross-sectional view illustrating a spindle motor according to an embodiment of the present invention, FIG. 2 is a schematic cut-away perspective view illustrating a sleeve provided in a spindle motor according to the embodiment of the present invention, and FIG. 3 is a schematic exploded cut-away perspective view illustrating a hub and a stopper provided in the spindle motor according to the embodiment of the present invention.

Referring to FIGS. 1 through 3, a spindle motor 100 according to the embodiment of the present invention may include a hub 110, a rotating member, a sleeve 120, a fixed member, and a stopper 130 for preventing the rotating member from overfloating.

First, the terms with respect to directions will be defined. When being viewed in FIG. 1, an axial direction refers to a vertical direction based on a shaft 140, and inner diameter and outer diameter directions refer to a direction toward an outside of a hub 110 or vice versa, based on the shaft 140.

Further, a circumferential direction refers to a direction in which the hub 110 and the shaft 140 rotate about a circumferential surface of the shaft 140.

The hub 110 may be a rotating structure rotated together with the shaft 140 and rotatably disposed with respect to the fixed member including the base 150.

Here, an inner circumferential surface of the hub 110 may be provided with an annular ring type magnet 180 corresponding to a core 170 around which a coil 160 coupled to a base 150 is wound, by a predetermined interval between the core 170 and the magnet 180.

The magnet 180 may be a member that provides a rotational driving force to the spindle motor 100 according to the embodiment of the present invention, wherein the rotational driving force may be generated by electromagnetic interaction with the coil 160 wound around the core 170.

The shaft 140 is a rotating member fitted to the hub 110 so as to rotate together with the hub 110 and may be supported by the sleeve 120.

Here, the sleeve 120 is a component that supports the shaft 140, a component of the rotating members, and may support the shaft 140 so that an upper portion of the shaft 140 is protruded upwardly in an axial direction and may be formed by forging Cu or Al or sintering Cu—Fe-based alloy powders or SUS-based powders.

Further, the sleeve 120 may be provided with a shaft hole into which the shaft 140 is inserted so as to form a micro gap between the shaft 140 and the sleeve 120, and the micro gap is filled with oil O such that the sleeve 120 may stably support the shaft 140 by a radial dynamic pressure via the oil O.

In this case, the radial dynamic pressure generated in the oil O may be generated by upper and lower fluid dynamic parts 124 and 126 that are formed to be concave in an inner circumferential surface of the sleeve 120 and the upper and lower fluid dynamic parts 124 and 126 may have a herringbone shaped pattern.

While FIGS. 1 and 2 illustrate that the upper and lower fluid dynamic parts 124 and 126 have the herringbone shaped pattern, but the embodiment of the present invention is not limited thereto. Therefore, the upper and lower fluid dynamic parts 124 and 126 may have one of a spiral shape or a helical shape.

Here, as described above, the upper and lower fluid dynamic parts 124 and 126 are not necessarily formed in the inner circumferential surface of the sleeve 120. Therefore, the upper and lower fluid dynamic parts 124 and 126 may be formed in an outer circumferential surface of the shaft 140, a rotating member, and the number thereof is not limited.

Further, an upper surface of the sleeve 120 may be provided with a thrust dynamic part 128 that generates thrust dynamic pressure in the oil O and rotating members including the shaft 140 may be rotated by the thrust dynamic part 128 while securing a predetermined amount of floating force.

Here, a shape of the thrust dynamic part 128 may be a groove having a herringbone shaped pattern, a spiral shaped pattern, or a helical (screw) shaped pattern, similar to the upper and lower fluid dynamic parts 124 and 126, but the embodiment of the present invention is not necessarily limited thereto. Therefore, as long as the shape of the thrust dynamic part 128 can provide the thrust dynamic pressure, there may be no limitation on the shape thereof.

Further, the thrust dynamic part 128 is not necessarily formed in the upper surface of the sleeve 120 and therefore, may be formed in one surface of the hub 110 corresponding to the upper surface of the sleeve 120.

Further, a lower portion of the sleeve 120 may be coupled to a base cover 190 to close the lower portion of the sleeve 120, and the spindle motor 100 according to the embodiment of the present invention may have a full-fill structure due to the base cover 190.

Further, an edge of the upper portion of the sleeve 120 may be provided with a locking part 122, protruded in a radial direction, and the locking part 122 may be configured to prevent overfloating when the rotating members including the shaft 140 and the hub 110 are rotated while floating.

That is, the locking part 122 contacts the stopper 130 fitted in the hub 110 when the rotating members including the hub 110 overflote, to prevent the rotating members from overfloating, thereby preventing the rotating members from separating from the fixed members including the sleeve 120.

Here, the hub 110 may be disposed outside the sleeve 120 and may be provided with a wall part 112, protruded downwardly in an axial direction, wherein the wall part 112 may be provided with the stopper 130.

The wall part 112 may be seamlessly formed in a circumferential direction and may be provided with a coupling part 114 with a step so as to be coupled to the stopper 130.

Here, the coupling part 114 may include a first coupling part 114a coupled to an upper surface of the stopper 130 and a second coupling part 114b coupled to an outer circumferential surface of the stopper 130, and the detailed coupling relationship thereof will be described below.

Meanwhile, describing the stopper 130 mounted on the coupling part 114 in detail, the stopper 130 may be a component that prevents the rotating members including the shaft 140 and the hub 110 from overfloating as described above.

That is, the stopper 130 may be fixed by being coupled to the coupling part 114 of the wall part 112 formed in the hub 110 and may contact the locking part 122 of the sleeve 120 to prevent the rotating members from overfloating.

Here, the stopper 130 may be seamlessly formed in a circumferential direction along an inner circumferential surface of the wall part 112 and may prevent the rotating members including the shaft 140 and the hub 110 from separating from the fixed members including the sleeve 120 and the base 150 due to external impacts.

Further, the stopper 130 may prevent the hub 110 from separating from the shaft 140 due to the stopper 130 not being fixed to the shaft 140.

That is, according to the spindle motor of the related art, the stopper is coupled to a lower end of the shaft so as to prevent the rotating member from overfloating, and when the rotating members overfloat, the stopper contacts the bottom surface of the sleeve to prevent the rotating members from overfloating.

The stopper structure according to the related art does not contact the hub but only contacts the sleeve when the external impact is applied thereto, to prevent the separation of the shaft, but does not greatly serve to prevent the hub from separating from the shaft.

However, the stopper 130 according to the embodiment of the present invention may contact the sleeve 120 while being coupled to the coupling part 114 of the hub 110 to prevent the separation of the shaft 140 due to the external impact and the separation of the hub 110 from the shaft 140.

Further, the stopper 130 structure according to the embodiment of the present invention may increase a bearing span length S to increase the rigidity of the bearing as a whole.

Here, describing the bearing span length S with reference to the spindle motor 100 according to the embodiment of the present invention, the bearing span length S refers to a distance between peak pressure generation points in dynamic pressure generated by the upper fluid dynamic part 124 and the lower fluid dynamic part 126, and as the distance is increased, the rotation of the shaft 140 may be stably supported.

In other words, as the distance between the peak pressure generation points generated by the upper fluid dynamic part 124 and the lower fluid dynamic part 126 is increased, a distance between support points supporting the shaft 140 is increased, such that the rigidity of the bearing is improved, thereby improving the rotation characteristic.

Comparing this with the related art, according to the spindle motor of the related art, the stopper is provided on an lower axial portion such that the axial length of the sleeve is relatively reduced due to a space occupied by the stopper as compared to the motor without the stopper. As a result, the bearing span length cannot but be relatively small.

However, according to the spindle motor 100 of the embodiment of the present invention, the stopper 130 is disposed outside the sleeve 120 to remove the space occupied by the stopper according to the related art, thereby increasing the axial length of the sleeve 120 as compared to the spindle motor according to the related art.

Therefore, the bearing span length S is increased and thus, the supporting force supporting the rotating members including the shaft 140 and the hub 110 may be increased, such that the rigidity of the bearing may be improved.

Here, describing the coupling relationship between the stopper 130 to prevent the rotating members from overfloating and the hub 110 provided, first, the stopper 130 and the hub 110 may be firmly fixed by a press-fitting scheme and a bonding scheme using an adhesive B.

That is, one of opposing surfaces of the stopper 130 and the hub 110 may be provided with at least one press-fitting groove 132 for press-fitting the stopper 130 in the hub 110, and the other of opposing surfaces of the stopper and the hub may be provided with at least one press-fitting protrusion 116 press-fitted to the press-fitting groove 132.

In other words, as illustrated in FIGS. 1 through 3, the press-fitting groove 132 and the press-fitting protrusion 116 are seamlessly formed in a circumferential direction and may be symmetrical with each other based on a rotational center of the shaft 140 and may respectively be formed in the stopper 130 and the hub 110.

In detail, the press-fitting groove 132 may be formed in the upper surface of the stopper 130 and the press-fitting protrusion 116 may be formed on one surface of the hub 110 that faces the upper surface of the stopper 130.

Here, describing the detailed position of the hub 110 on which the stopper 130 is mounted, the hub 110 may be provided with the wall part 112 protruded downwardly in an axial direction as described above, and the wall part 112 may be provided with the coupling part 114 so as to be coupled to the stopper 130.

Meanwhile, the coupling part 114 may include the first coupling part 114a coupled to the upper surface of the stopper 130, and the second coupling part 114b coupled to the outer circumferential surface of the stopper 130, and the first coupling part 114a may be provided with the press-fitting protrusion 116.

Here, in order to press-fit the press-fitting protrusion 116 in the press-fitting groove 132, a width of the press-fitting protrusion 116 in a radial direction thereof may be formed to be slightly greater than that of the press-fitting groove 132 in a radial direction thereof, and a length in an axial direction of the press-fitting groove 132 may be formed to be greater than that of the press-fitting protrusion 116.

Therefore, after the press-fitting protrusion 116 is press-fitted and fixed in the press-fitting groove 132, a predetermined space may be formed between the press-fitting protrusion 116 and the press-fitting groove 132, but the embodiment of the present invention is not necessarily limited thereto.

Meanwhile, in order to fix the stopper 130 to the wall part 112 of the hub 110, the stopper 130 is slid to the second coupling part 114b of the wall part 112, and then, the press-fitting groove 132 of the stopper 130 is press-fitted to the press-fitting protrusion 116 formed in the first coupling part 114a, such that the stopper 130 may be primarily fixed to the wall part 112.

Further, the stopper 130 and the wall part 112 are primarily fixed by the press-fitting protrusion 116 and the press-fitting groove 132 and then, the stopper 130 and the wall part 112 may be finally fixed between the outer circumferential surface of the stopper 130 and the inner circumferential surface of the wall part 112, that is, the second coupling part 114b, by the bonding process using the adhesive B.

Therefore, the spindle motor 100 according to the embodiment of the present invention may prevent the change in a position of the stopper 130 when the stopper 130 is fitted in the hub 110.

In other words, according to the related art, when intending to fit the stopper in the hub, the stopper is entirely press-fitted to the wall part formed in the hub and then, is bonded by an adhesive, but in this case, the adhesive is not filled below the press-fitted portion, such that the fixing force of the stopper may be deteriorated.

Further, when the stopper is entirely not press-fitted to the wall part but is slid thereto and is then bonded by the adhesive, a pressing jig for temporarily fixing the stopper is necessarily required at the time of hardening the adhesive. In this case, a space in which the pressing jig can press the stopper is relatively narrow and thus, the pressing cannot be accurately performed.

Further, when the pressing jig is not used, the position of the stopper may be changed at the time of hardening the adhesive.

However, according to the embodiment of the present invention, the stopper 130 is primarily fixed to the wall part 112 by press-fitting the press-fitting groove 132 formed in the upper surface of the stopper 130 to the press-fitting protrusion 116 formed on the first coupling part 114a of the wall part 112, thereby resolving the foregoing defects.

In addition, the case in which the press-fitting groove 132 and the press-fitting protrusion 116 are respectively formed in the stopper 130 and the wall part 112 of the hub 110 is described above, but the embodiment of the present invention is not limited thereto and the opposite can be made.

Further, the case in which the press-fitting groove 132 and the press-fitting protrusion 116 are seamlessly formed in a circumferential direction is described above, but the embodiment of the present invention is not limited thereto and the press-fitting groove 132 and the press-fitting protrusion 116 may be spacedly formed in a circumferential direction

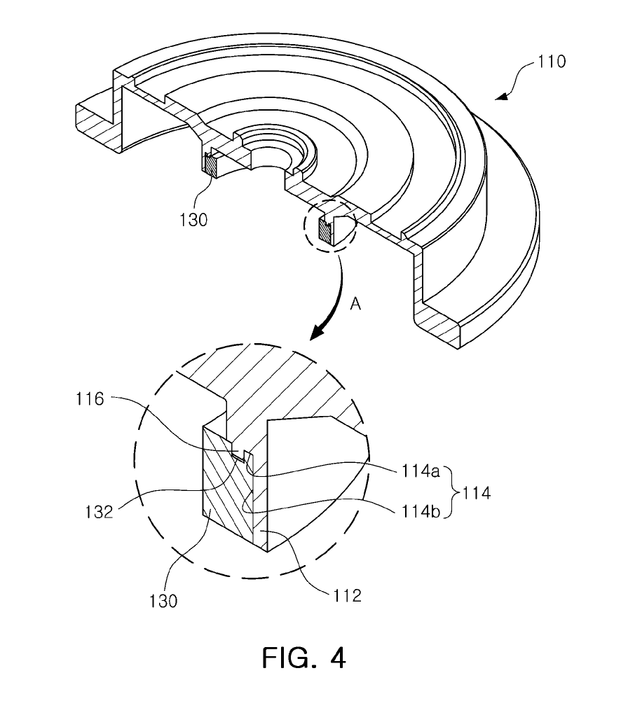

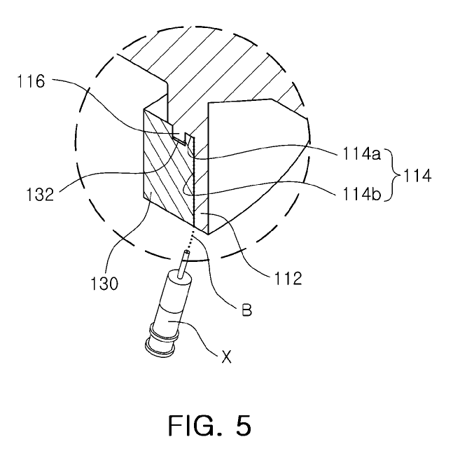

FIG. 4 is a schematic cut-away perspective view illustrating a hub and a stopper provided in the spindle motor according to the embodiment of the present invention, coupled by press-fitting, and FIG. 5 is a schematic cut-away perspective view (illustrating section A of FIG. 4) illustrating a state in which the hub and the stopper are fixed to each other by an adhesive after the hub and the stopper provided in the spindle motor according to the embodiment of the present invention are coupled by press-fitting.

Referring to FIGS. 4 and 5, in order to fit the stopper 130 in the hub 110, the stopper 130 is slid to the second coupling part 114b of the wall part 112 formed in the hub 110 and then, the press-fitting groove 132 of the stopper 130 is press-fitted to the press-fitting protrusion 116 formed in the first coupling part 114a of the wall part 112, such that the stopper 130 may be primarily fixed to the hub 110.

Therefore, the pressing jig required in the related art is not required, thereby simplifying the coupling process.

Meanwhile, the stopper 130 is primarily fixed to the hub 110 and then, the adhesive B is filled between the stopper 130 and the second coupling part 114b of the wall part 112 by an adhesive filling apparatus X and is hardened, such that the stopper 130 may be finally fixed to the hub 110.

Therefore, the stopper 130 is primarily fixed to the hub 110 by the press-fitting protrusion 116 and the press-fitting groove 132 and thus, the change in the position of the stopper 130 due to the hardening of the adhesive B while the coupling process is performed without the pressing jig does not occur.

As a result, the stopper 130 may be simply and firmly fixed to the hub 110 and therefore, the function of the stopper 130 for preventing the rotating members from overfloating may be improved, such that the performance and lifespan of the spindle motor 100 may be significantly increased.

As set forth above, according to the spindle motor of the embodiments of the present invention, the bearing span length may be significantly increased, thereby improving the rigidity of the bearing.

Further, the stopper may be prevented from being changed in a position thereof due to the coupling when the stopper for preventing the rotating members from overfloating is fitted in and coupled to the hub, thereby significantly improving the performance and lifespan of the spindle motor.

While the present invention has been shown and described in connection with the embodiments, it will be apparent to those skilled in the art that modifications and variations can be made without departing from the spirit and scope of the invention as defined by the appended claims.

What is claimed is:

1. A spindle motor, comprising:
a hub rotated together with a shaft;
a sleeve supporting rotation of the shaft via oil; and
a stopper mounted on the hub to prevent the hub from overfloating with respect to the sleeve,
one of opposing surfaces of the stopper and the hub being provided with at least one press-fitting groove for press-fitting the stopper in the hub, and the other of the opposing surfaces of the stopper and the hub being provided with at least one press-fitting protrusion press-fitted to the press-fitting groove.

2. The spindle motor of claim 1, wherein the press-fitting groove is formed in the stopper, and
the press-fitting protrusion is formed on the hub.

3. The spindle motor of claim 1, wherein the press-fitting groove is formed on an upper surface of the stopper, and
the press-fitting protrusion is formed on one surface of the hub facing the upper surface of the stopper.

4. The spindle motor of claim 1, wherein the press-fitting groove and the press-fitting protrusion are seamlessly or spacedly formed in a circumferential direction.

5. The spindle motor of claim 1, wherein the press-fitting groove and the press-fitting protrusion are symmetrically formed, based on a rotational center of the shaft.

6. The spindle motor of claim 1, wherein the hub is provided with a wall part protruded axially downwardly from an outer surface of the sleeve, and
the stopper is mounted on the wall part.

7. The spindle motor of claim 6, wherein an outer circumferential surface of the stopper and an inner circumferential surface of the wall part are coupled to each other by an adhesive.

8. The spindle motor of claim 1, wherein the stopper contacts the sleeve to prevent the shaft from overfloating.
